(19) United States
(12) Patent Application Publication
(10) Pub. No.: US 2025/0112290 A1
(43) Pub. Date: Apr. 3, 2025

(54) VEHICLE BATTERY COOLING SYSTEM

(71) Applicant: SUBARU CORPORATION, Tokyo (JP)

(72) Inventor: Shingo KATO, Tokyo (JP)

(21) Appl. No.: 18/891,187

(22) Filed: Sep. 20, 2024

(30) Foreign Application Priority Data
Sep. 29, 2023 (JP) 2023-169215

(51) Int. Cl. H01M 10/635; H01M 10/625; H01M 10/6563

(52) U.S. Cl. CPC H01M 10/635; H01M 10/625; H01M 10/6563

(57) ABSTRACT

A vehicle battery cooling system cools a battery in a vehicle, by supplying air in a vehicle compartment of the vehicle to a battery compartment containing the battery, using a battery cooling fan. The vehicle battery cooling system includes first and second temperature sensors and a control apparatus. The first temperature sensor detects a temperature of the battery. The second temperature sensor detects a temperature in the vehicle compartment. The control apparatus controls driving of the battery cooling fan. The control apparatus: estimates an outside air temperature outside the vehicle; estimates an output of a blower fan of an air conditioner in the vehicle, based on a difference between the temperature in the vehicle compartment and the estimated outside air temperature; and controls an output of the battery cooling fan, based on the estimated output of the blower fan of the air conditioner and the temperature of the battery.

### CROSS-REFERENCE TO RELATED APPLICATIONS

The present application claims priority from Japanese Patent Application No. 2023-169215 filed on Sep. 29, 2023, the entire contents of which are hereby incorporated by reference.

### BACKGROUND

The disclosure relates to a vehicle battery cooling system.

An electric vehicle or a hybrid electric vehicle including a drive motor as a driving force source is equipped with a battery serving as an electric power source of the drive motor. It is known that the battery deteriorates due to a temperature rise that is caused by heat generation through repeated charging and discharging and the influence of an ambient temperature. For this reason, the vehicle is equipped with a battery cooling system. Examples of a vehicle battery cooling system include a system that cools a battery by supplying air in a vehicle compartment to the battery using a cooling fan.

For the above-described battery cooling system, a technique has been proposed to reduce the possibility that operating sound of the cooling fan is heard as noise to an occupant. For example, Japanese Unexamined Patent Application Publication (JP-A) Nos. 2010-193602 and 2013-216173 disclose techniques in which a control apparatus controls driving of a cooling fan to make operating sound of the cooling fan smaller than operating sound of a blower fan of an air conditioner.

### SUMMARY

An aspect of the disclosure provides a vehicle battery cooling system configured to cool a battery in a vehicle, by supplying air in a vehicle compartment of the vehicle to a battery compartment containing the battery, with use of a battery cooling fan. The vehicle battery cooling system includes a first temperature sensor, a second temperature sensor, and a control apparatus. The first temperature sensor is configured to detect a temperature of the battery. The second temperature sensor is configured to detect a temperature in the vehicle compartment. The control apparatus is configured to control driving of the battery cooling fan. The control apparatus is configured to perform: a first estimation process of estimating an outside air temperature outside the vehicle; a second estimation process of estimating an output of a blower fan of an air conditioner in the vehicle, based on a difference between the temperature in the vehicle compartment detected by the second temperature sensor and the outside air temperature estimated in the first estimation process; and a control process of controlling an output of the battery cooling fan, based on the output of the blower fan of the air conditioner estimated in the second estimation process and the temperature of the battery detected by the first temperature sensor.

An aspect of the disclosure provides a vehicle battery cooling system configured to cool a battery in a vehicle, by supplying air in a vehicle compartment of the vehicle to a battery compartment containing the battery, with use of a battery cooling fan. The vehicle battery cooling system includes a first temperature sensor, a second temperature sensor, and circuitry. The first temperature sensor is configured to detect a temperature of the battery. The second temperature sensor is configured to detect a temperature in the vehicle compartment. The control apparatus is configured to control driving of the battery cooling fan. The circuitry is configured to perform: a first estimation process of estimating an outside air temperature outside the vehicle; a second estimation process of estimating an output of a blower fan of an air conditioner in the vehicle, based on a difference between the temperature in the vehicle compartment detected by the second temperature sensor and the outside air temperature estimated in the first estimation process; and a control process of controlling an output of the battery cooling fan, based on the output of the blower fan of the air conditioner estimated in the second estimation process and the temperature of the battery detected by the first temperature sensor.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram illustrating a configuration example of a vehicle battery cooling system according to one example embodiment of the disclosure.

FIG. 2 is an explanatory diagram illustrating a configuration of a control mechanism of the battery cooling system according to one example embodiment.

FIG. 3 is a logic diagram for calculating a driving duty ratio of a battery cooling fan according to one example embodiment.

FIG. 4 is a flowchart illustrating processing operation of controlling driving of the battery cooling fan according to one example embodiment.

FIG. 5 is a flowchart illustrating an outside air temperature estimation process according to one example embodiment.

FIG. 6 is a flowchart illustrating a reference temperature recording process according to one example embodiment.

FIG. 7 is a schematic diagram illustrating a method of calculating an estimated outside air temperature according to one example embodiment.

FIG. 8 is an explanatory diagram illustrating an example of a blower fan output estimation map according to one example embodiment.

FIG. 9 is an explanatory diagram illustrating a change in a vehicle compartment temperature after a startup of an electric power system.

FIG. 10 is a flowchart illustrating a vehicle compartment temperature acquisition and definition process according to one example embodiment.

FIG. 11 is a flowchart illustrating processing operation of controlling driving of the battery cooling fan according to an application example.

### DETAILED DESCRIPTION

A vehicle battery cooling system has to be subjected to malfunction diagnosis by on-board diagnostics (OBD), and component including sensors and control equipment that are used to control the battery cooling system are to be subjected to the malfunction diagnosis. The components to be subjected to the malfunction diagnosis are requested to comply with OBD requirements. Such components are hereinafter also referred to as “OBD target components”. When techniques disclosed in JP-A Nos. 2010-193602 and 2013-216173 acquire a signal indicating an output of a blower fan from an air conditioner not included in the battery cooling system, components that detect or calculate the output of the blower fan fall under the OBD target components, and measures are to be taken accordingly.

It is desirable to provide a vehicle battery cooling system that makes it possible to drive a battery cooling fan to make operating sound of the battery cooling fan smaller than operating sound of a blower fan of an air conditioner, without using a transmitted signal from the air conditioner.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Overall Configuration of Battery Cooling System

First, an example of an overall configuration of a vehicle battery cooling system (also referred to as a “battery cooling system”) according to an example embodiment of the disclosure will be described with reference to FIG. 1.

FIG. 1 is an explanatory diagram schematically illustrating a vehicle equipped with the vehicle battery cooling system according to the example embodiment. As illustrated in FIG. 1, a vehicle 1 may include a battery 20, a battery cooling system 10, and an air conditioning system 40.

The battery 20 may be a secondary battery that supplies electric power to an unillustrated drive motor provided as a driving force source of the vehicle 1. The battery 20 may include multiple battery cells. The battery 20 may be, for example, a lithium-ion battery having a rated voltage of 200 V, but the battery 20 is not particularly limited in kind or rated output. The battery 20 may be contained in a battery compartment 25.

The air conditioning system 40 may perform air conditioning in a vehicle compartment 30 using an air conditioner 26. The air conditioning system 40 may include an air conditioning duct 41, the air conditioner 26, and a blower fan 27. The air conditioning duct 41 may be a passage for air circulation, and allow for communication between the outside of the vehicle 1 and the inside of the vehicle compartment 30. The air conditioning duct 41 may have a first intake port 41a in communication with the outside of the vehicle 1, and a second intake port 41b in communication with the inside of the vehicle compartment 30. The air conditioner 26 may include a switching damper 28 and the blower fan 27. The switching damper 28 may be provided in the air conditioning duct 41. The blower fan 27 may be a blower disposed on the vehicle compartment 30 side with respect to the switching damper 28. The switching damper 28 may switch opening and closing of the first intake port 41a and the second intake port 41b of the air conditioning duct 41. The blower fan 27 may be driven by an unillustrated blower motor.

The switching damper 28 closing the first intake port 41a and opening the second intake port 41b while the blower fan 27 is driven may result in an inside air circulation mode. In the inside air circulation mode, inside air of the vehicle 1 may be introduced from the second intake port 41b into the air conditioner 26, and blown out from an outlet of the air conditioner 26 into the vehicle compartment 30. In contrast, the switching damper 28 opening the first intake port 41a and closing the second intake port 41b while the blower fan 27 is driven may result in an outside air introduction mode. In the outside air introduction mode, outside air may be taken from the first intake port 41a into the air conditioning duct 41 to be introduced into the air conditioner 26, and blown out from the outlet of the air conditioner 26 into the vehicle compartment 30.

The air conditioner 26 may adjust a temperature of the air to be supplied into the vehicle compartment 30 to bring a vehicle compartment temperature to a set temperature. The vehicle compartment temperature may be detected by a vehicle compartment temperature sensor that detects a temperature in the vehicle compartment 30. In the example embodiment, used as the vehicle compartment temperature detected by the vehicle compartment temperature sensor may be an intake air temperature detected by a vehicle compartment temperature sensor that is a component of the battery cooling system 10. In one embodiment, the vehicle compartment temperature sensor may serve as a “second temperature sensor”. Alternatively, the vehicle compartment temperature sensor that detects the vehicle compartment temperature may be installed in the vehicle compartment 30 separately from the vehicle compartment temperature sensor of the battery cooling system 10.

The battery cooling system 10 supplies air in the vehicle compartment 30 to the battery compartment 25 including the battery 20, with use of a battery cooling fan 22, to cool the battery 20. An occupant may usually adjust the set temperature of the air conditioner 26 to set the vehicle compartment temperature of the vehicle compartment 30 to about 20° C. to 30° C. The battery cooling system 10 may cool the battery 20 by supplying the thus temperature-adjusted air in the vehicle compartment 30 to the battery compartment 25, to prevent the battery 20 from overheating.

The battery cooling system 10 may include the battery cooling fan 22, a cooling duct 42, and an exhaust duct 44. The cooling duct 42 may allow for communication between the vehicle compartment 30 and the battery compartment 25. The exhaust duct 44 may configure a discharge path for communication between the battery compartment 25 and the outside of the vehicle. The exhaust duct 44 may have an air vent grille 49. The air vent grille 49 may open when an air pressure inside the vehicle becomes high, and discharge air to the outside of the vehicle.

The battery compartment 25 may be disposed between the vehicle compartment 30 and a luggage compartment 32 in the rear of the vehicle, in the vicinity of a rear seat 19 provided in the vehicle compartment 30. In the example embodiment, the battery compartment 25 may be disposed below the rear seat 19. The battery cooling fan 22 may be disposed in the cooling duct 42. The battery cooling fan 22 may be driven by an unillustrated fan motor to supply the air in the vehicle compartment 30 to the battery compartment 25.

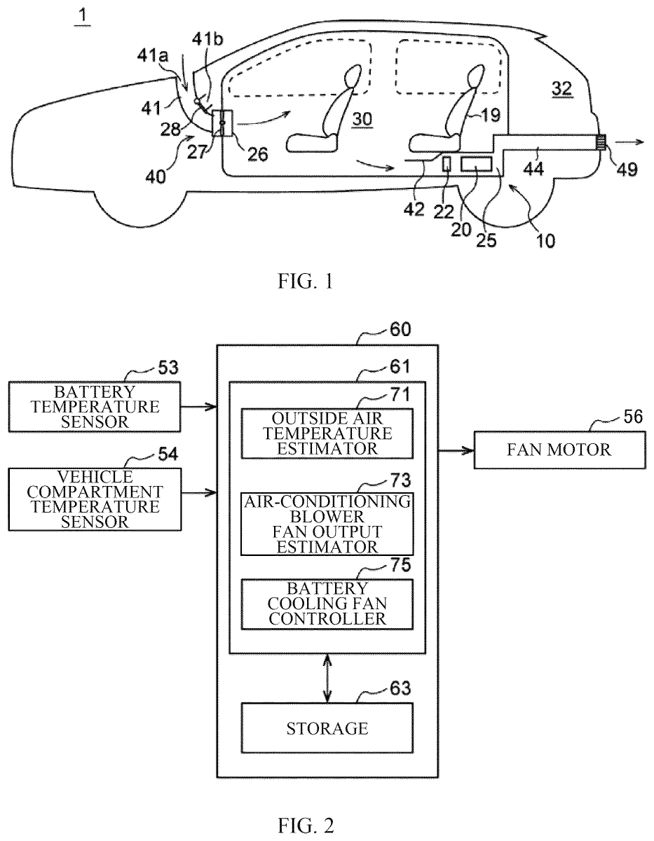

FIG. 2 is an explanatory diagram illustrating a configuration of a control mechanism of the battery cooling system 10. As illustrated in FIG. 2, the battery cooling system 10 may include a battery temperature sensor 53, a vehicle compartment temperature sensor 54, a fan motor 56, and a control apparatus 60. The fan motor 56 may drive the cooling fan 22. The control apparatus 60 may be an electronic control unit (ECU). In one embodiment, the battery temperature sensor 53 may serve as a “first temperature sensor”. In one embodiment, the vehicle compartment temperature sensor 54 may serve as the “second temperature sensor”.

The battery temperature sensor 53 detects a temperature T_bt of the battery 20 (hereinafter, also referred to as a battery temperature T_bt). The battery temperature sensor 53 may be provided in the battery 20 or the battery compartment 25, and directly or indirectly detect the temperature of the battery 20. The vehicle compartment temperature sensor 54 detects a temperature T_ab in the vehicle compartment 30 (hereinafter, also referred to as a vehicle compartment temperature T_ab). In the example embodiment, the vehicle compartment temperature sensor 54 may be provided in the cooling duct 42. Alternatively, the vehicle compartment temperature sensor 54 may be provided in the vehicle compartment 30, or provided on the vehicle compartment 30 side with respect to the battery 20 in the battery compartment 25.

The control apparatus 60 may include a processing unit 61, a storage 63, and an unillustrated input-output interface. The processing unit 61 may include a processor such as a central processing unit (CPU). The storage 63 may be communicably connected to the processing unit 61 and include, for example, a random-access memory (RAM) or a read-only memory (ROM). The control apparatus 60 may be communicably coupled to the battery temperature sensor 53, the vehicle compartment temperature sensor 54, and the fan motor 56. The control apparatus 60 performs a process of controlling an output of the battery cooling fan 22 to cool the battery 20.

### 2. Configuration of Control Apparatus

Next, the control apparatus 60 of the battery cooling system 10 will be described in detail.

The control apparatus 60 may serve as an apparatus that performs a process of driving the fan motor 56 to cool the battery 20 when a processor such as one or more CPUs executes a computer program. The computer program may be a computer program that causes the processor to execute later-described operation to be performed by the control apparatus 60. The computer program to be executed by the processor may be recorded in a recording medium serving as the storage 63 provided in the control apparatus 60. Alternatively, the computer program to be executed by the processor may be recorded in a recording medium built in the control apparatus 60 or any recording medium externally attachable to the control apparatus 60.

The recording medium that records the computer program may include: a magnetic medium such as a hard disk, a floppy disk, or a magnetic tape; an optical recording medium such as a compact disk read-only memory (CD-ROM), a digital versatile disk (DVD), or Blu-ray (registered trademark); a magneto-optical medium such as a floptical disk; a storage element such as a RAM or a ROM; a flash memory such as a universal serial bus (USB) memory or a solid state drive (SSD); or any other medium that is able to store programs.

As illustrated in FIG. 2, the processing unit 61 of the control apparatus 60 may include an outside air temperature estimator 71, an air-conditioning blower fan output estimator 73, and a battery cooling fan controller 75. The outside air temperature estimator 71, the air-conditioning blower fan output estimator 73, and the battery cooling fan controller 75 may be implemented by the processor executing programs. Note that a part of the outside air temperature estimator 71, the air-conditioning blower fan output estimator 73, and the battery cooling fan controller 75 may include hardware such as an analogue circuit.

The outside air temperature estimator 71 performs an outside air temperature estimation process of estimating an outside air temperature outside the vehicle. In other words, the battery cooling system 10 may be configured to estimate the outside air temperature by calculation, instead of acquiring a sensor signal of a temperature sensor that is provided in the vehicle 1 and detects the outside air temperature. This configuration makes it possible to use data regarding the outside air temperature without increasing the number of OBD target components. In one embodiment, the outside air temperature estimation process may serve as a “first estimation process”.

The air-conditioning blower fan output estimator 73 performs an air-conditioning blower fan output estimation process of estimating an output of the blower fan 27 of the air conditioner 26, based on a difference between the vehicle compartment temperature T_ab and the estimated outside air temperature (hereinafter, also referred to as an “estimated outside air temperature T_am”). In other words, the battery cooling system 10 may be configured to estimate the output of the blower fan 27 by calculation, instead of acquiring data regarding the output of the blower fan 27 from the air conditioner 26 of the air conditioning system 40. This configuration makes it possible to use the data regarding the output of the blower fan 27 without increasing the number of OBD target components. In one embodiment, the air-conditioning blower fan output estimation process may serve as a “second estimation process”.

The battery cooling fan controller 75 performs a battery cooling fan control process of controlling the output of the battery cooling fan 22, based on the estimated output of the blower fan 27 and the battery temperature T_bt. This suppresses overheating of the battery 20, making it possible to suppress deterioration of the battery 20. In one embodiment, the battery cooling fan control process may serve as a “control process”.

### 3. Processing Operation

Next, processing operation of the control for cooling the battery 20 by the control apparatus 60 will be described.

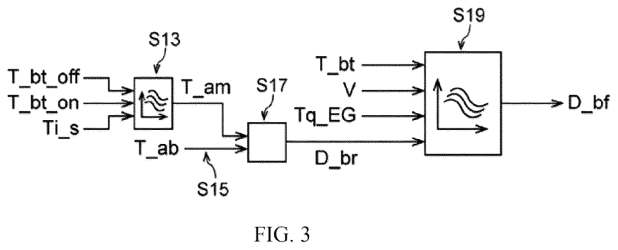

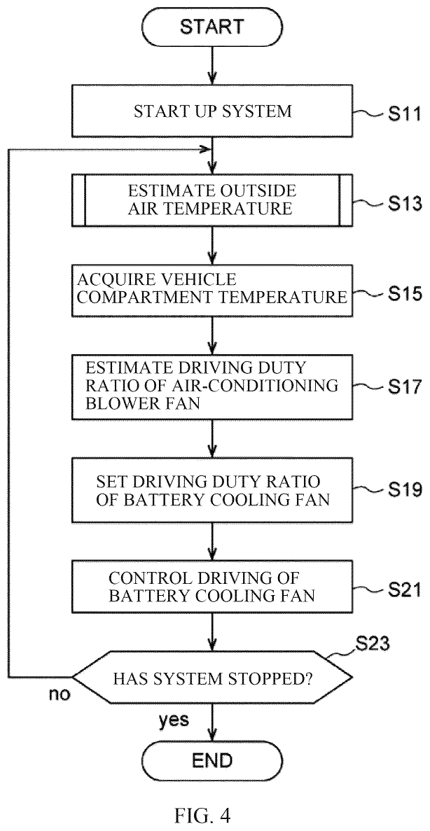

FIGS. 3 and 4 are explanatory diagrams illustrating the process operation that is performed by the processing unit 61 of the control apparatus 60. FIG. 3 is a logic diagram for calculating a driving duty ratio D_bf of the battery cooling fan 22. FIG. 4 is a flowchart illustrating the process operation of controlling the driving of the battery cooling fan 22.

First, when the battery cooling system 10 is started up (step S11), the outside air temperature estimator 71 of the processing unit 61 may perform the process of estimating the outside air temperature (step S13). In the example embodiment, the outside air temperature estimator 71 may calculate the estimated outside air temperature T_am based on: a battery temperature (reference temperature) T_bt_off detected at a predetermined time when an electric power system including the battery 20 is in a stopped state; a battery temperature (startup temperature) T_bt_on when the electric power system is started up; and elapsed time Ti_s from the predetermined time when the reference temperature T_bt_off is detected to the time when the startup temperature T_bt_on is detected. The outside air temperature estimation process may be a process of estimating the outside air temperature from a change in the battery temperature T_bt while the electric power system is stopped. The outside air temperature estimator 71 may calculate the estimated outside air temperature T_am using the components of the battery cooling system 10.

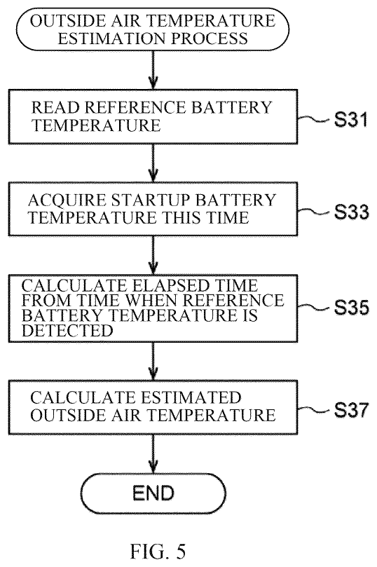

FIG. 5 is a flowchart illustrating the outside air temperature estimation process.

First, the outside air temperature estimator 71 may read the reference temperature T_bt_off recorded in the storage 63 (step S31). The reference temperature T_bt_off may be the battery temperature T_bt detected by the battery temperature sensor 53 after the electric power system was stopped last time until the electric power system is started up this time, and may be recorded in the storage 63 together with data regarding the time of detection. The reference temperature T_bt_off may be detected at least once in a period after the electric power system was stopped last time until the electric power system is started up this time.

If excessively long time elapses from the time when the reference temperature T_bt_off is detected until the electric power system is started up, the outside air temperature can repeatedly rise and fall during that time, which can result in a decrease in calculation accuracy of the estimated outside air temperature T_am based on the battery temperature T_bt. For this reason, in the example embodiment, the outside air temperature estimator 71 may detect the battery temperature T_bt every predetermined time period after the electric power system was stopped last time until the electric power system is started up this time, and record the battery temperature T_bt in the storage 63 together with the time of detection.

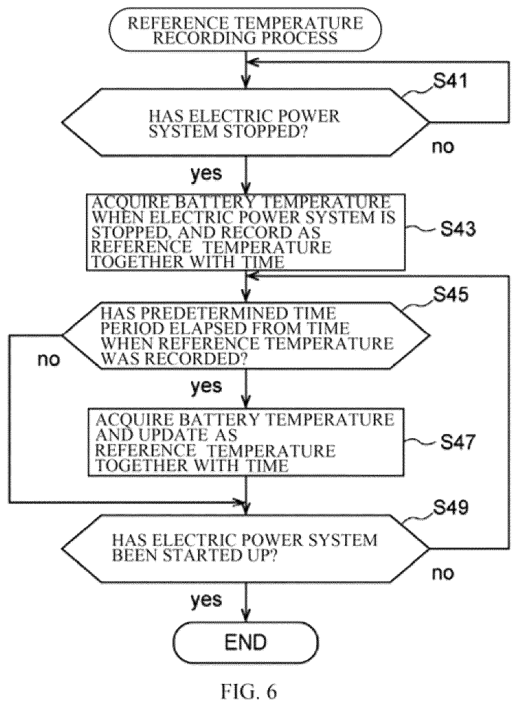

FIG. 6 is a flowchart illustrating a reference temperature recording process. The flowchart illustrated in FIG. 6 may be executed while the electric power system including the battery 20 is in operation, or may start to be executed when it is determined that the battery cooling system 10 has stopped (step S23/Yes) in the flowchart illustrated in FIG. 4.

First, the outside air temperature estimator 71 may determine whether the electric power system including the battery 20 has stopped (step S41). Instead of determining whether the electric power system has stopped, the outside air temperature estimator 71 may determine whether the battery cooling system 10 has stopped. In this case, step S41 may be replaced with step S23 of the flowchart illustrated in FIG. 4.

When it is not determined that the electric power system has stopped (S41/No), the outside air temperature estimator 71 may repeat the determination of step S41. In contrast, when it is determined that the electric power system is stopped (S41/Yes), the outside air temperature estimator 71 may acquire the battery temperature T_bt detected by the battery temperature sensor 53, and record the battery temperature T_bt as the reference temperature T_bt_off in the storage 63 together with the time of detection (step S43).

Thereafter, the outside air temperature estimator 71 may determine whether the predetermined time period has elapsed from the time when the reference temperature T_bt_off was recorded in step S43 (step S45). The predetermined time period may be set to, for example, 4 hours, but may be set to any time period. Note that, if the predetermined time period is too long, the battery temperature T_bt can repeatedly rise and fall due to the influence of the outside air temperature when long time elapses until the electric power system is started up next. This can make it difficult to calculate the estimated outside air temperature T_am based on the change in the battery temperature T_bt and the elapsed time Ti_s. Accordingly, the predetermined time period may be set to an appropriate time period considering the accuracy of the estimated outside air temperature T_am calculated based on the change in the battery temperature T_bt and the elapsed time Ti_s.

When it is not determined that the predetermined time period has elapsed from the time when the reference temperature T_bt_off was recorded (S45/No), the outside air temperature estimator 71 may cause the process to proceed to step S49. In contrast, when it is determined that the predetermined time period has elapsed from the time when the reference temperature T_bt_off was recorded (S45/Yes), the outside air temperature estimator 71 may acquire the battery temperature T_bt detected by the battery temperature sensor 53, and update the data recorded as the reference temperature T_bt_off in the storage 63 together with the time of detection (step S47).

Thereafter, the outside air temperature estimator 71 may determine whether the electric power system has been started up (step S49). When it is not determined that the electric power system has been started up (S49/No), the outside air temperature estimator 71 may cause the process to return to step S45, and repeat the determination of the elapse of the predetermined time period (step S45) and the update of the reference temperature T_bt_off (step S47). In contrast, when it is determined that the electric power system has been started up (S49/Yes), the outside air temperature estimator 71 may end the process of recording the reference temperature.

Returning to FIG. 5, after reading the reference temperature T_bt_off in step S31, the outside air temperature estimator 71 may acquire the battery temperature (startup temperature) T_bt_on detected by the battery temperature sensor 53 when the electric power system is started up this time (step S33). Thereafter, the outside air temperature estimator 71 may calculate the elapsed time Ti_s from the time when the reference temperature T_bt_off is detected to the time when the startup temperature T_bt_on is detected (step S35).

Thereafter, the outside air temperature estimator 71 may calculate the estimated outside air temperature T_am, based on the reference temperature T_bt_off, the startup-time-temperature T_bt_on, and the elapsed time Ti_s (step S37). For example, the outside air temperature estimator 71 may calculate the estimated outside air temperature T_am from an outside air temperature estimation map stored in the storage 63 in advance, using the reference temperature T_bt_off, the startup-time-temperature T_bt_on, and the elapsed time Ti_s as input data.

FIG. 7 is a schematic diagram illustrating a method of calculating the estimated outside air temperature T_am.

When the outside air temperature is lower than the battery temperature T_bt, the battery temperature T_bt gradually decreases while the vehicle 1 is stopped. A decrease rate of the battery temperature T_bt (an amount of temporal change in the battery temperature T_bt) at this time depends on the battery temperature T_bt and the outside air temperature. In other words, finding the battery temperature T_bt and the decrease rate of the subsequent battery temperature T_bt makes it possible to estimate the outside air temperature.

As illustrated in FIG. 7, the decrease rate of the battery temperature T_bt is relatively high when the elapsed time from the stop (SW-OFF) of the electric power system is short and a difference between the battery temperature T_bt and the outside air temperature is relatively large. Thereafter, the difference between the battery temperature T_bt and the outside air temperature decreases and the decrease rate of the battery temperature T_bt becomes relatively low as the elapsed time from the stop (SW-OFF) of the electric power system becomes longer.

The battery temperature T_bt may be cooled by the battery cooling system 10 while the electric power system is in operation. The battery temperature T_bt when the electric power system is stopped (SW-OFF) may thus be held at, for example, a temperature lower than 35° C. to 40° C. Accordingly, for example, regarding the battery temperatures T_bt lower than 35° C. to 40° C., the decrease rate of the battery temperature T_bt corresponding to the outside air temperature may be measured using actual equipment or simulated in advance, to thereby create the outside air temperature estimation map.

In this manner, the outside air temperature estimator 71 may perform the outside air temperature estimation process along the flowchart illustrated in FIG. 5. It is thus possible for the outside air temperature estimator 71 to calculate the estimated outside air temperature T_am using the components of the battery cooling system 10, without acquiring a signal indicating the outside air temperature from another sensor or system, such as an outside air temperature sensor.

Returning to FIG. 4, after the estimated outside air temperature T_am is calculated in step S13, the air-conditioning blower fan output estimator 73 may acquire data regarding the vehicle compartment temperature T_ab detected by the vehicle compartment temperature sensor 54 (step S15). In the example embodiment, the air-conditioning blower fan output estimator 73 may acquire the data regarding the temperature detected by the vehicle compartment temperature sensor 54 provided in the cooling duct 42.

Thereafter, the air-conditioning blower fan output estimator 73 may estimate a driving duty ratio D_br of the blower fan 27 of the air conditioner 26 (step S17). The output of the blower fan 27 may be controlled by adjusting the driving duty ratio D_br that is a ratio of energization time in each predetermined time cycle. The air conditioner 26 may adjust the vehicle compartment temperature T_ab to the set temperature by supplying temperature-adjusted air into the vehicle compartment 30 using the blower fan 27. To bring the vehicle compartment temperature T_ab to the set temperature as early as possible, the output of the blower fan 27 may be made greater as a difference between the outside air temperature and the vehicle compartment temperature T_ab becomes larger. Accordingly, the air-conditioning blower fan output estimator 73 may calculate the driving duty ratio D_br of the blower fan 27 from a blower fan output estimation map stored in the storage 63 in advance, using the estimated outside air temperature T_am and the vehicle compartment temperature T_ab as input data.

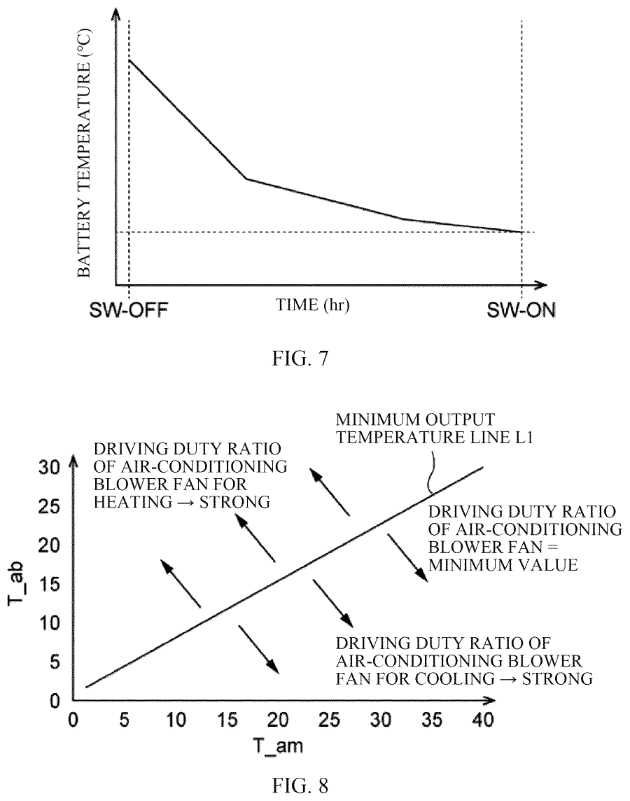

FIG. 8 is an explanatory diagram illustrating an example of the blower fan output estimation map.

The blower fan 27 to which the blower fan output estimation map illustrated in FIG. 8 is applicable may be driven at a driving duty ratio of a predetermined minimum value when the outside air temperature is on a minimum output temperature line L1. The minimum output temperature line L1 may be obtained by multiplying the vehicle compartment temperature by a predetermined factor (1.33 in the example of FIG. 8). When the outside air temperature is lower than the minimum output temperature line L1, the air conditioner 26 may operate as a heater, and the output of the blower fan 27 may become greater as the difference between the outside air temperature and the vehicle compartment temperature becomes larger. In contrast, when the outside air temperature is higher than the minimum output temperature line L1, the air conditioner 26 may operate as a cooler, and the output of the blower fan 27 may become greater as the difference between the outside air temperature and the vehicle compartment temperature becomes larger. Accordingly, the blower fan output estimation map may be created in advance based on data for setting the driving duty ratio D_br of the blower fan 27.

In this manner, it is possible for the air-conditioning blower fan output estimator 73 to calculate the driving duty ratio D_br of the blower fan 27 using the components of the battery cooling system 10, without acquiring a signal indicating the output of the blower fan 27 from the air conditioner 26.

Returning to FIG. 4, after the driving duty ratio D_br of the blower fan 27 of the air conditioner 26 is estimated in step S17, the battery cooling fan controller 75 may set the driving duty ratio D_bf of the battery cooling fan 22 (step S19). The battery cooling fan controller 75 may set the driving duty ratio D_bf of the battery cooling fan 22, based on the estimated driving duty ratio D_br of the blower fan 27 and the battery temperature T_bt, to prevent operating sound of the battery cooling fan 22 from being heard as noise to the occupant. At this time, the battery cooling fan controller 75 may set the greatest driving duty ratio D_bf within a range where the operating sound of the battery cooling fan 22 is not heard as noise to the occupant. The output of the battery cooling fan 22 may be controlled by adjusting the driving duty ratio D_bf that is a ratio of energization time in each predetermined time cycle.

In the example embodiment, the driving of the battery cooling fan 22 may be controlled to make the operating sound of the battery cooling fan 22 less likely to be heard to the occupant, by considering background noise as well as operating sound of the blower fan 27 of the air conditioner 26. The background noise may include, for example, operating sound of an engine of the vehicle 1, wind noise caused by the vehicle 1 traveling, and road noise caused by friction between a tire and a road surface. For example, the battery cooling fan controller 75 may calculate the driving duty ratio D_bf of the battery cooling fan 22 from a cooling fan output setting map stored in the storage 63 in advance, using the battery temperature T_bt detected by the battery temperature sensor 53, a vehicle speed V detected by an unillustrated vehicle speed sensor, an output torque or target torque Tq_EG of the engine, and the driving duty ratio D_br of the blower fan 27 as input data.

As the battery temperature T_bt becomes higher and more different from a target battery temperature, it is further desired to cool the battery 20, and the driving duty ratio D_bf of the battery cooling fan 22 may thus be set to a larger value. As the vehicle speed V becomes higher, the wind noise and the road noise become larger, resulting in larger background noise, and the driving duty ratio D_bf of the battery cooling fan 22 may thus be set to a larger value. As the output torque or target torque Tq_EG of the engine becomes greater, the operating sound of the engine becomes larger, and the driving duty ratio D_bf of the battery cooling fan 22 may thus be set to a larger value.

Data regarding the vehicle speed V and the output torque or target torque Tq_EG of the engine may be included in data acquired by the electric power system as data to be used to control charging and discharging by the electric power system including the battery 20. Thus, constructing the battery cooling system 10 does not cause an increase in the number of OBD target components.

In addition, to consider a degree to which the background noise caused by the vehicle 1 as the vehicle 1 travels is likely to be heard to the occupant in the vehicle compartment 30, the cooling fan output setting map may further include data regarding a degree of opening and closing of a side window as input data. In addition, when the vehicle 1 is an electric vehicle without an engine, the cooling fan output setting map may be a map not including data such as the output torque of the engine.

Thereafter, the battery cooling fan controller 75 may control the driving of the fan motor 56 of the battery cooling fan 22 based on the set driving duty ratio D_bf (step S21). Thereafter, the battery cooling fan controller 75 may determine whether the battery cooling system 10 has stopped (step S23). When it is not determined that the battery cooling system 10 has stopped (S23/No), the process may return to step S13, and the processes of the steps described above may be repeatedly executed. In contrast, when it is determined that the battery cooling system 10 has stopped (S23/Yes), the battery cooling fan controller 75 may end the process of cooling the battery 20.

As described above, the battery cooling system 10 according to at least one embodiment of the disclosure controls the driving of the battery cooling fan 22 to make the operating sound of the battery cooling fan 22 heard to the occupant smaller than the operating sound of the blower fan 27 of the air conditioner 26, without using a transmitted signal from the air conditioner 26. For example, the control apparatus 60 may estimate the outside air temperature based on the temporal change in the battery temperature T_bt. In addition, the control apparatus 60 may estimate the driving duty ratio D_br of the blower fan 27 based on the estimated outside air temperature T_am and the vehicle compartment temperature T_ab. Thus, it is possible to control the driving of the battery cooling fan 22 without using the air conditioner 26 or an outside air temperature sensor or a solar sensor that detects the outside air temperature as an OBD target component to be subjected to malfunction diagnosis of the battery cooling system 10. This makes it possible to reduce the number of OBD target components of the battery cooling system 10.

In some embodiments, the battery cooling system 10 may update, every predetermined time period, the reference temperature T_bt_off of the battery 20 detected when the electric power system is in the stopped state to be used to calculate the estimated outside air temperature T_am. This makes it possible to suppress a decrease in the accuracy of the estimated outside air temperature T_am estimated based on the reference temperature T_bt_off and the decrease rate of the battery temperature T_bt, and to make the operating sound of the battery cooling fan 22 less likely to be heard as noise to the occupant.

### 4. Application Example

Next, an application example of the above-described example embodiment will be described.

After the occupant starts using the vehicle 1, it takes a predetermined time for the temperature in the vehicle compartment 30 to be stabilized by operation of the air conditioning system 40. When the above-described battery cooling fan control process is performed while the vehicle compartment temperature T_ab is unstable, hunting can occur in which the output of the blower fan 27 estimated using the vehicle compartment temperature T_ab fluctuates up and down, which can result in hunting of the output of the battery cooling fan 22 to be set. For this reason, a battery cooling system according to the application example may not start the definition of the vehicle compartment temperature T_ab to be used to estimate the output of the blower fan 27 until the vehicle compartment temperature T_ab is stabilized, but start the definition of the vehicle compartment temperature T_ab after the vehicle compartment temperature T_ab is stabilized.

“Starting the definition of the vehicle compartment temperature T_ab” may indicate using the vehicle compartment temperature T_ab detected by the vehicle compartment temperature sensor 54 in the process of estimating the output of the blower fan 27 of the air conditioner 26.

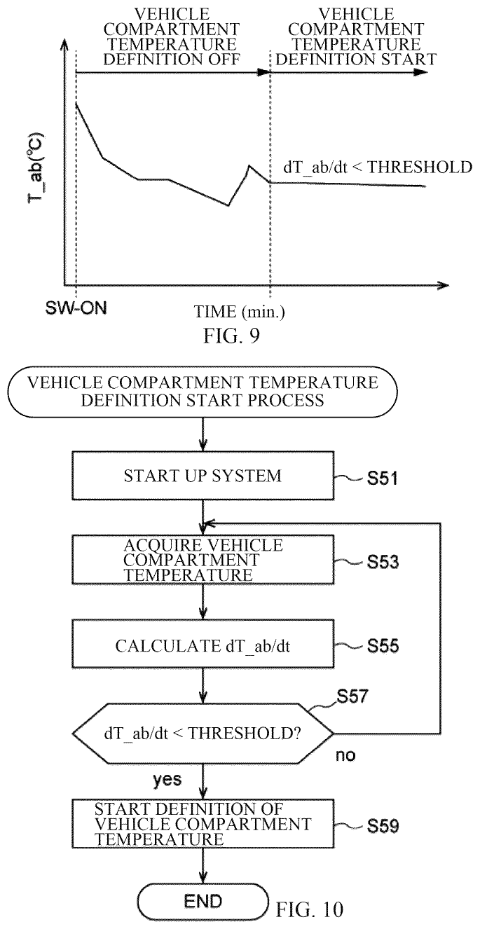

FIGS. 9 and 10 are explanatory diagrams illustrating a vehicle compartment temperature definition start process that is performed by the battery cooling system according to the application example. FIG. 9 is an explanatory diagram illustrating a change in the vehicle compartment temperature T_ab after the startup (SW-ON) of the electric power system including the battery 20. FIG. 10 is a flowchart illustrating a vehicle compartment temperature acquisition and definition process.

When the electric power system is started up (step S51), the air-conditioning blower fan output estimator 73 may acquire the vehicle compartment temperature T_ab detected by the vehicle compartment temperature sensor 54 (step S53). The vehicle compartment temperature T_ab may be acquired in a predetermined sampling cycle set in advance.

Thereafter, the air-conditioning blower fan output estimator 73 may calculate a change rate dT_ab/dt of the vehicle compartment temperature T_ab, based on the vehicle compartment temperature T_ab acquired in the previous sampling cycle, the vehicle compartment temperature T_ab acquired in the current sampling cycle, and a time interval dt of the sampling cycle (step S55). The air-conditioning blower fan output estimator 73 may calculate the change rate dT_ab/dt of the vehicle compartment temperature T_ab by dividing, by the time-interval dt, a difference dT_ab obtained by subtracting the vehicle compartment temperature T_ab acquired in the previous sampling cycle from the vehicle compartment temperature T_ab acquired in the current sampling cycle.

When the vehicle compartment temperature T_ab is first acquired after the startup of the electric power system, the change rate dT_ab/dt of the vehicle compartment temperature T_ab is not calculable. Accordingly, the air-conditioning blower fan output estimator 73 may skip step S55 and subsequent step S57 and cause the process to return to step S53.

Thereafter, the air-conditioning blower fan output estimator 73 may determine whether the change rate dT_ab/dt of the vehicle compartment temperature T_ab is less than a predetermined threshold set in advance (step S57). The predetermined threshold may be set to any appropriate value in order to determine whether the vehicle compartment temperature T_ab has been stabilized. When it is not determined that the change rate dT_ab/dt of the vehicle compartment temperature T_ab is less than the predetermined threshold (S57/No), the air-conditioning blower fan output estimator 73 may cause the process to return to step S53, and repeat the acquisition of the vehicle compartment temperature T_ab (step S53) and the determination of the change rate dT_ab/dt of the vehicle compartment temperature T_ab (steps S55 and S57). This may correspond to a “vehicle compartment temperature definition off” period in FIG. 5.

In contrast, when it is determined that the change rate dT_ab/dt of the vehicle compartment temperature T_ab is less than the predetermined threshold (S57/Yes), the air-conditioning blower fan output estimator 73 may start the definition of the vehicle compartment temperature T_ab (step S59). The air-conditioning blower fan output estimator 73 may thus end the vehicle compartment temperature definition start process. Thereafter, the estimation of the output of the blower fan 27 of the air conditioner 26 using the data regarding the vehicle compartment temperature T_ab may be started. This may correspond to a “vehicle compartment temperature defined start” period in FIG. 5.

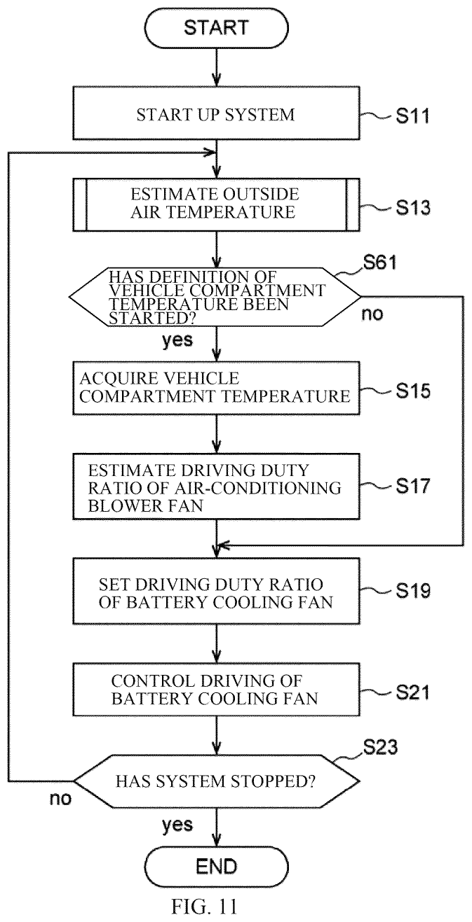

FIG. 11 is a flowchart illustrating processing operation of controlling driving of the battery cooling fan 22 by the battery cooling system according to the application example.

In the application example, after the estimated outside air temperature T_am is calculated in step S13, the air-conditioning blower fan output estimator 73 may determine whether the definition of the vehicle compartment temperature T_ab has been started (step S61). When it is determined that the definition of the vehicle compartment temperature T_ab has been started (S61/Yes), the air-conditioning blower fan output estimator 73 may cause the process to proceed to step S15, and the processing unit 61 may control the driving of the battery cooling fan 22 in accordance with the procedure described in the above-described example embodiment.

In contrast, when it is not determined that the definition of the vehicle compartment temperature T_ab has been started (S61/No), the air-conditioning blower fan output estimator 73 may cause the process to proceed to step S19, and the battery cooling fan controller 75 may set the driving duty ratio D_bf of the battery cooling fan 22 to a predetermined minimum value (step S19). The battery cooling fan controller 75 may control the driving of the battery cooling fan 22 at the minimum driving duty ratio D_bf (step S21).

In this manner, in the application example, the battery cooling fan 22 may be controlled at the minimum driving duty ratio D_bf after the startup of the battery cooling system 10, until the vehicle compartment temperature T_ab detected by the vehicle compartment temperature sensor 54 is stabilized. This makes it possible to prevent hunting of the output of the battery cooling fan 22 due to hunting of the output of the blower fan 27 of the air conditioner 26 estimated using the vehicle compartment temperature T_ab.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The control apparatus 60 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control apparatus 60. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control apparatus 60 illustrated in FIG. 2.

1. A vehicle battery cooling system configured to cool a battery in a vehicle, by supplying air in a vehicle compartment of the vehicle to a battery compartment containing the battery, with use of a battery cooling fan, the vehicle battery cooling system comprising:
a first temperature sensor configured to detect a temperature of the battery;
a second temperature sensor configured to detect a temperature in the vehicle compartment; and
a control apparatus configured to control driving of the battery cooling fan, wherein
the control apparatus is configured to perform
a first estimation process of estimating an outside air temperature outside the vehicle,
a second estimation process of estimating an output of a blower fan of an air conditioner in the vehicle, based on a difference between the temperature in the vehicle compartment detected by the second temperature sensor and the outside air temperature estimated in the first estimation process, and
a control process of controlling an output of the battery cooling fan, based on the output of the blower fan of the air conditioner estimated in the second estimation process and the temperature of the battery detected by the first temperature sensor.

2. The vehicle battery cooling system according to claim 1, wherein the control apparatus is configured to estimate the outside air temperature based on the temperature of the battery in the first estimation process.

3. The vehicle battery cooling system according to claim 2, wherein, in the first estimation process, the control apparatus is configured to estimate the outside air temperature based on
a reference temperature that is the temperature of the battery detected at a predetermined time when an electric power system comprising the battery is in a stopped state,
a startup temperature that is the temperature of the battery when the electric power system is started up, and
elapsed time from the predetermined time when the reference temperature is detected to a time when the startup temperature is detected.

4. The vehicle battery cooling system according to claim 3, wherein the control apparatus is configured to
detect the temperature of the battery using the first temperature sensor every predetermined time period after the electric power system is set to the stopped state,
record the temperature of the battery as the reference temperature, together with a time when the temperature of the battery is detected, and
use the recorded temperature of the battery and the recorded time when the temperature of the battery is detected for the estimating of the outside air temperature in the first estimation process.

5. The vehicle battery cooling system according to claim 1, wherein, after a startup of an electric power system comprising the battery, the control apparatus is configured to start the control process after a change rate of the temperature in the vehicle compartment becomes less than a predetermined threshold.

6. A vehicle battery cooling system configured to cool a battery in a vehicle, by supplying air in a vehicle compartment of the vehicle to a battery compartment containing the battery, with use of a battery cooling fan, the vehicle battery cooling system comprising:
a first temperature sensor configured to detect a temperature of the battery;
a second temperature sensor configured to detect a temperature in the vehicle compartment; and
circuitry configured to control driving of the battery cooling fan, wherein
the circuitry is configured to perform
a first estimation process of estimating an outside air temperature outside the vehicle,
a second estimation process of estimating an output of a blower fan of an air conditioner in the vehicle, based on a difference between the temperature in the vehicle compartment detected by the second temperature sensor and the outside air temperature estimated in the first estimation process, and
a control process of controlling an output of the battery cooling fan, based on the output of the blower fan of the air conditioner estimated in the second estimation process and the temperature of the battery detected by the first temperature sensor.
